(19) United States
(12) Patent Application Publication
(10) Pub. No.: US 2026/0369911 A1
(43) Pub. Date: Nov. 19, 2026

(54) SOCKET TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kenichi KITAOKA, Mie (JP); Akihiro HAYASHI, Mie (JP); Daisuke HASHIMOTO, Mie (JP); Kentaro TACHI, Mie (JP)

(21) Appl. No.: 19/136,893

(22) PCT Filed: Nov. 28, 2023
(86) PCT No.: PCT/JP2023/042495

§ 371 Date: Jun. 9, 2025

(30) Foreign Application Priority Data
Dec. 14, 2022 (JP) 2022-199334

(51) Int. Cl. H01R 13/18; H01R 4/18; H01R 13/11; H01R 13/193

(52) U.S. Cl. CPC H01R 13/18; H01R 4/184; H01R 13/111; H01R 13/193

(57) ABSTRACT

The purpose of the present invention is to facilitate connection work while achieving high reliability in connection between a pin terminal and a socket terminal. This socket terminal is such that a pin terminal is to be connected thereto, the socket terminal comprising a cylindrical portion that has a cylindrical base portion and a plurality of spring contact pieces arranged in the circumferential direction of the cylindrical base portion, and a biasing member that is fitted onto the cylindrical portion, wherein each of the plurality of spring contact pieces extends from the cylindrical base portion in the axial direction of the cylindrical base portion and is capable of elastic deformation in the radial direction of the cylindrical base portion, and the biasing member biases each of the plurality of spring contact pieces inward to impart contact pressure from each of the plurality of spring contact pieces to the pin terminal, the biasing member being configured from a shape memory alloy that has memorized a shape such that the contact pressure is increased in accordance with an increase in temperature.

### Technical Field

The present disclosure relates to a socket terminal.

### BACKGROUND

Patent Document 1 discloses a socket terminal provided with a tube portion fittable to a mating pin terminal. It is disclosed in Patent Document 1 that the tube portion of the socket terminal includes a base portion and a plurality of fingers extending in an axial direction of the tube portion from the base portion, provided side by side at intervals in a circumferential direction of the tube portion and resiliently deformable in a radial direction of the tube portion, and an outer spring ring for biasing the fingers radially inwardly of the tube portion to reduce a diameter is fit on the outer periphery of a region formed with the fingers, out of the tube portion.

### PRIOR ART DOCUMENT

### Patent Document

Patent Document 1: JP 2009-054374 A

### SUMMARY OF THE INVENTION

### Problems to be Solved

In a connection location of the pin terminal and the socket terminal, an increase of a contact pressure at a contact location is possibly requested for vibration resistance and the suppression of contact heat generation. However, if the contact pressure is increased, a force required for connection increases and connection workability is possibly deteriorated.

Accordingly, the present disclosure aims to facilitate a connecting operation while obtaining high connection reliability of a pin terminal and a socket terminal.

### Means to Solve the Problem

The present disclosure is directed to a socket terminal to be connected to a pin terminal, the socket terminal being provided with a tube portion including a tubular base portion and a plurality of spring contact pieces arranged in a circumferential direction of the tubular base portion, and a biasing member externally fit to the tube portion, each of the plurality of spring contact pieces extending from the tubular base portion along an axial direction of the tubular base portion and resiliently deformable in a radial direction of the tubular base portion, the biasing member applying a contact pressure to the pin terminal from each of the plurality of spring contact pieces by biasing each of the plurality of spring contact pieces toward an inner peripheral side, and the biasing member being made of shape-memory alloy remembering a form to increase the contact pressure by a temperature rise.

### Effect of the Invention

According to the present disclosure, a connecting operation can be easily performed while high connection reliability of a pin terminal and a socket terminal is obtained.

### BRIEF DESCRIPTION OF THE DRAWINGS

FIG. 1 is a perspective view showing a socket terminal according to an embodiment.

FIG. 2 is a perspective view showing the socket terminal according to the embodiment.

FIG. 3 is an exploded perspective view showing the socket terminal.

FIG. 4 is a section along IV-IV of FIG. 1.

FIG. 5 is a section along V-V of FIG. 1.

### DETAILED DESCRIPTION TO EXECUTE THE INVENTION

### Description of Embodiments of Present Disclosure

First, embodiments of the present disclosure are listed and described.

The socket terminal of the present disclosure is as follows.

(1) The socket terminal of the present disclosure is to be connected to a pin terminal and provided with a tube portion including a tubular base portion and a plurality of spring contact pieces arranged in a circumferential direction of the tubular base portion, and a biasing member externally fit to the tube portion, each of the plurality of spring contact pieces extending from the tubular base portion along an axial direction of the tubular base portion and resiliently deformable in a radial direction of the tubular base portion, the biasing member applying a contact pressure to the pin terminal from each of the plurality of spring contact pieces by biasing each of the plurality of spring contact pieces toward an inner peripheral side, and the biasing member being made of shape-memory alloy remembering a form to increase the contact pressure by a temperature rise.

According to this socket terminal, a connecting operation is easily performed by inserting the pin terminal into the tube portion for connection in a state before a temperature rise. Further, since the contact pressure of the spring contact pieces and the pin terminal is increased by a temperature rise after connection, high connection reliability can be obtained. Further, the spring contact pieces are arranged along the circumferential direction of the tubular base portion and surround the outer periphery of the pin terminal. Thus, heat generated at a connection location of the pin terminal and the tube portion and the like is easily transferred to the biasing member. In this way, the contact pressure is effectively increased and even higher connection reliability can be obtained.

(2) In the socket terminal of (1), the tubular base portion may be formed into a hollow cylindrical shape.

In this way, the tubular base portion can be formed into a shape suitable for the connection of the pin terminal in the form of an easily processable round bar.

(3) In the socket terminal of (2), an inner peripheral part of each of the plurality of spring contact pieces may include an arcuate contact portion convex toward an outer peripheral side when viewed in a direction along a center axis of the tubular base portion.

In this way, a contact area of the arcuate contact portion with the pin terminal can be increased, and the connection reliability of the pin terminal and the spring contact piece is improved. Further, the heat of the pin terminal is effectively transferred to the biasing member.

(4) In the socket terminal of any one of (1) to (3), a slit may be present between two adjacent ones of the plurality of spring contact pieces, and the biasing member may bias each of the plurality of spring contact pieces in a direction to narrow a gap of the slit.

In this case, the plurality of spring contact pieces can contact the pin terminal with the slit narrowed in a biasing state of the biasing member by a temperature rise. In this way, as large a part as possible of the entire periphery of the pin terminal can contact the spring contact pieces, the connection reliability of the pin terminal and the spring contact pieces is improved and the heat of the pin terminal is effectively transferred to a biasing force.

(5) In the socket terminal of any one of (1) to (4), the biasing member may include a surrounding portion for surrounding the plurality of spring contact pieces from an outer peripheral side and a crimping/fixing portion crimped and fixed to the tube portion.

In this way, the position deviation or detachment of the biasing member from the tube portion is suppressed in a state where a biasing force is small before heating.

(6) In the socket terminal of any one of (1) to (5), the biasing member may bias each of the plurality of spring contact pieces toward the inner peripheral side by contacting a part of each of the plurality of spring contact pieces closer to a tip side than a center thereof in an extension direction.

In this case, by biasing the spring contact pieces at positions distant from base end parts of the spring contact pieces, the biasing force of the pin terminal can be increased as compared to the case where the biasing member biases base end sides of the spring contact pieces.

(7) In the socket terminal of any one of (1) to (6), each of the plurality of spring contact pieces may be capable of contacting the pin terminal at a position closer to a tip side than a center thereof in an extension direction.

In this case, a part in contact with the pin terminal, out of the spring contact piece, can be largely displaced. In this way, a contact state of the spring contact piece with the pin terminal is easily adjusted by slight deformation of the spring contact piece.

(8) In the socket terminal of any one of (1) to (7), the spring contact piece may include a base end side region extending from the tubular base portion and a tip side region extending from the base end side region toward a side away from the tubular base portion, and an angle of inclination of the tip side region with respect to a center axis of the tubular base portion may be smaller than an angle of inclination of the base end side region with respect to the center axis of the tubular base portion, and at least a part of the tip side region may be capable of contacting the pin terminal.

In this case, the tip side region having the small angle of inclination is easily arranged over as large a contact area with the pin terminal as possible or as close to the pin terminal as possible. In this way, heat generated in the pin terminal is effectively transferred to the biasing member via the tube portion.

(9) In the socket terminal of (8), the biasing member may bias each of the plurality of spring contact pieces toward the inner peripheral side by contacting the tip side region.

In this case, the biasing member can be arranged near a heat generation location, heat is effectively transferred to the biasing member in contact with the tip side regions, and the biasing member can effectively generate the contact pressure.

(10) In the socket terminal of any one of (1) to (7), the biasing member may be made of Ni—Ti alloy or Ni—Ti—Cu alloy.

In this way, as the temperature increases, the shape of the biasing member can be returned to the original shape by shape memory and the contact pressure of the spring contact pieces and the pin terminal can be increased by increasing an elastic modulus.

### Details of Embodiment of Present Disclosure

A specific example of a socket terminal of the present disclosure is described below with reference to the drawings. Note that the present disclosure is not limited to these illustrations, but is represented by claims and intended to include all changes in the scope of claims and in the meaning and scope of equivalents.

### Embodiment

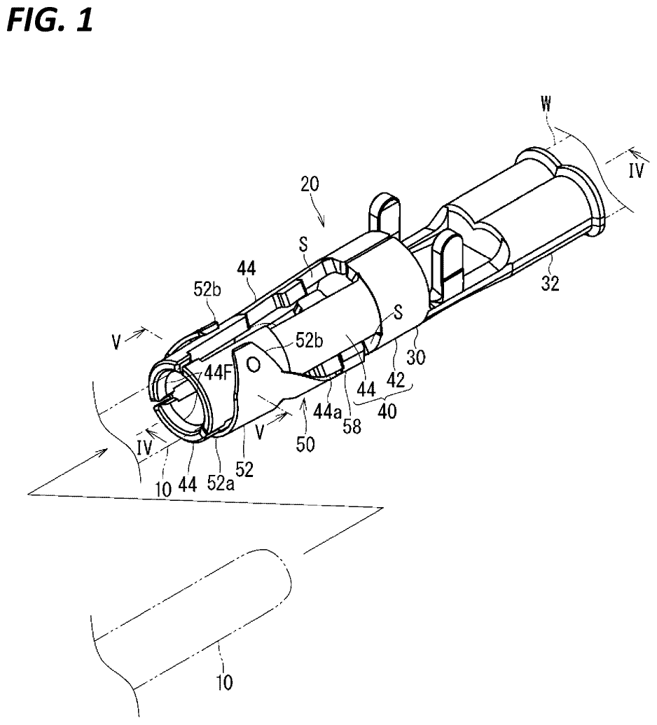

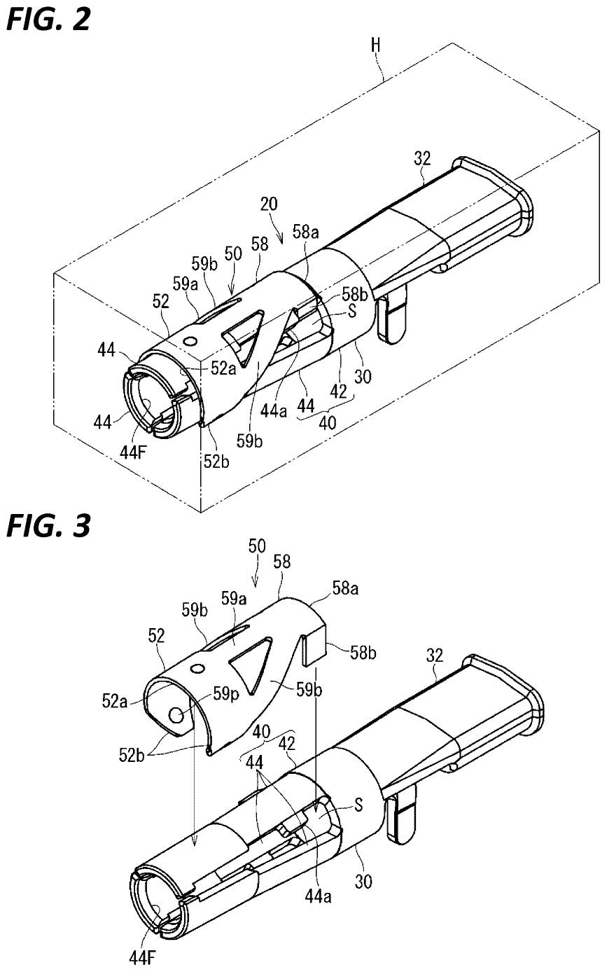

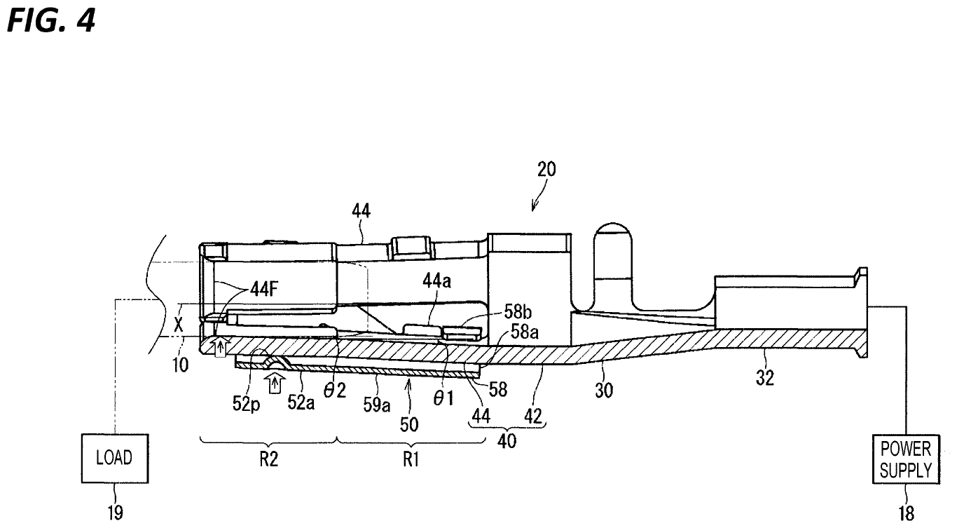

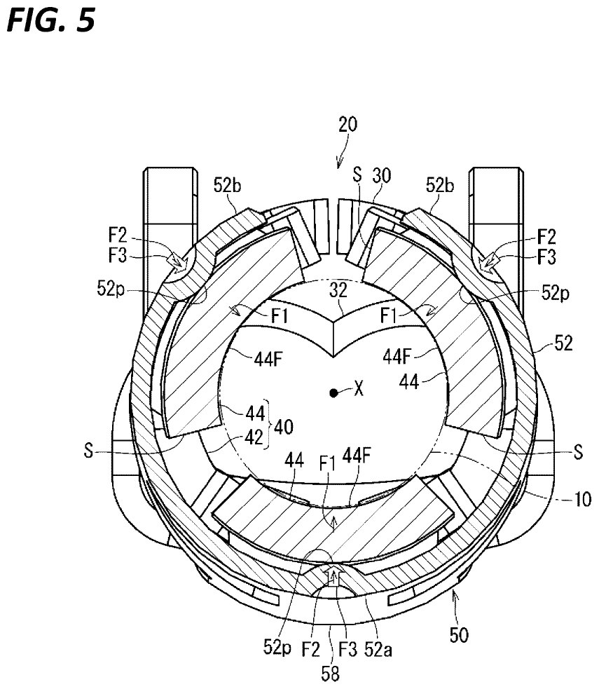

Hereinafter, a socket terminal according to an embodiment is described. FIGS. 1 and 2 are perspective views showing a socket terminal 20. FIG. 3 is an exploded perspective view showing the socket terminal 20. FIG. 4 is a section along IV-IV of FIG. 1. FIG. 5 is a section along V-V of FIG. 1. In FIGS. 1, 4 and 5, a pin terminal 10 is shown by two-dot chain lines.

The pin terminal 10 is connected to the socket terminal 20. For example, the socket terminal 20 is connected to a first electrical device via an electrical transmission medium such as a busbar or a wire. The pin terminal 10 is connected to a second electrical device via an electrical transmission medium such as a busbar or a wire. By connecting the pin terminal 10 to the socket terminal 20, the first and second electrical devices are electrically connected.

The socket terminal 20 and the pin terminal 10 may be a combination of terminals for connecting power lines. For example, the socket terminal 20 is connected to a power supply 18, and the pin terminal 10 is connected to a load 19 (see FIG. 4). By connecting the pin terminal 10 to the socket terminal 20, the power supply 18 and the load 19 are electrically connected. In this case, a current suitable for operating the load 19 flows at a contact location of the socket terminal 20 and the pin terminal 10. A large current flows at the contact location depending on the type of the load 19, e.g. if the load 19 is a motor or the like.

The socket terminal 20 is provided with a tube portion 40 and a biasing member 50. The socket terminal 20 may be connected to the pin terminal 10 while being accommodated in a housing H made of resin (see FIG. 2).

In this embodiment, the tube portion 40 is a part of a terminal body 30. The terminal body 30 is, for example, formed by press-working one metal plate. Since being a part serving as a current path, the terminal body 30 is preferably made of metal having a higher electrical conductivity than the biasing member 50. The terminal body 30 is, for example, formed by a copper plate or a copper alloy plate. Plating such as tin plating may be applied to the surface of the terminal body 30.

The terminal body 30 is provided with the tube portion 40 and a wire connecting portion 32. The tube portion 40 and the wire connecting portion 32 are linearly connected. The tube portion 40 and the wire connecting portion 32 may be connected in a curved manner.

The wire connecting portion 32 is crimped and connected to a core wire exposed in an end part of a wire W. A wire connecting portion may be configured to be connected to a round terminal at an end part of a wire W by screwing or the like. A wire connecting portion may be configured to be connected to an end part of a wire by welding, soldering or the like.

In the case of connecting a busbar or the like to a socket terminal, the socket terminal may be provided with a busbar connecting portion connectable to the busbar by screwing, welding or the like, instead of a wire connecting portion. In the case of connecting a socket terminal and an electrical transmission medium by a terminal, the socket terminal may include a terminal connecting portion, instead of a wire connecting portion.

The tube portion 40 includes a tubular base portion 42 and a plurality of spring contact pieces 44.

The tubular base portion 42 is formed into a tubular shape. The tubular base portion 42 is, for example, formed into a hollow cylindrical shape, more specifically into a short hollow cylindrical shape having an axial length smaller than an outer diameter. The tubular base portion 42 is, for example, formed by plastically deforming a strip-like part of the metal plate into a circular shape so that both ends butt against each other. The wire connecting portion 32 is connected to an intermediate part of the strip-like part constituting the tubular base portion 42.

It is not essential that the tubular base portion has a hollow cylindrical shape. The tubular base portion 42 may have an elliptical tube shape or may have a polygonal tube shape such as a triangular tube shape or a rectangular tube shape.

The plurality of spring contact pieces 44 are arranged in a circumferential direction of the tubular base portion 42. In this embodiment, the tube portion 40 includes three spring contact pieces 44. A tube portion may include two, four or more spring contact pieces.

The plurality of spring contact pieces 44 extend along an axial direction of the tubular base portion 42 from the tubular base portion 42. The plurality of spring contact pieces 44 need not be parallel to the axial direction of the tubular base portion 42. The plurality of spring contact pieces 44 may extend along the axial direction of the tubular base portion 42 in such a range that the pin terminal 10 can be inserted and held in a space surrounded by the plurality of spring contact pieces 44.

Further, the spring contact piece 44 is resiliently deformable in a radial direction of the tubular base portion 42. Here, a base end part of the spring contact piece 44 is connected to an end part of the tubular base portion 42 on a side opposite to the wire connecting portion 32. The spring contact piece 44 is in the form of a plate having a thickness in the radial direction of the tubular base portion 42 smaller than a width in the circumferential direction of the tubular base portion 42. The spring contact piece 44 can be resiliently deformed inwardly and outwardly along the radial direction of the tubular base portion 42 with a coupled location to the tubular base portion 42 as a support location.

Further, slits S are present between the plurality of spring contact pieces 44. The plurality of spring contact pieces 44 can be resiliently deformed inwardly and outwardly while changing widths of the slits S.

The slits S may have an equal width or non-uniform widths in a direction along a center axis of the tubular base portion 42. In this embodiment, the widths of the slits S become gradually smaller from base end sides toward tip sides of the spring contact pieces 44. In this way, gaps between arcuate contact portions 44F to be described later can be made as small as possible.

The pin terminal 10 is in the form of a round bar. A tip part of the pin terminal 10 may be formed into a shape gradually narrowed toward a tip side, e.g. a hemispherical shape. A part of the pin terminal 10 closer to the base end side than the tip part having a varying diameter is a trunk portion having a constant diameter. The pin terminal 10 may be, for example, a member obtained by applying plating to a body made of copper or copper alloy.

An inner diameter of the tubular base portion 42 is larger than an outer diameter of the pin terminal 10. A diameter of a virtual circle connecting locations of the plurality of spring contact pieces 44 closest to the center axis (see FIG. 5) of the tubular base portion 42 is smaller than the outer diameter of the pin terminal 10.

If the pin terminal 10 is inserted into the tube portion 40 through the tip side of the tube portion 40, the tip part of the pin terminal 10 contacts inner peripheral parts of the plurality of spring contact pieces 44. Then, the plurality of spring contact pieces 44 are resiliently deformed toward an outer peripheral side. In a connection completed state of the pin terminal 10 and the socket terminal 20, the trunk portion of the pin terminal 10 is in contact with the inner peripheral parts of the spring contact pieces 44. In a connected state of the terminals 10, 20, the plurality of spring contact pieces 44 are biased to the pin terminal 10 by resilient forces of the plurality of spring contact pieces 44 trying to return to original shapes.

The plurality of spring contact pieces 44 can contact the pin terminal 10 at positions closer to the tip sides than centers thereof in an extension direction. Here, the inner peripheral part of each of the plurality of spring contact pieces 44 includes the arcuate contact portion 44F convex toward the outer peripheral side when viewed in a direction along a center axis X of the tubular base portion 42. In this embodiment, the spring contact piece 44 has an arcuate shape having the center axis X as a center of curvature when viewed in the direction along the center axis X. Thus, the inner peripheral surface of the spring contact piece 44 has an arcuate shape having the center axis X as a center of curvature when viewed in the direction along the center axis X. An arcuate edge closest to the center axis X is formed on the tip side of the spring contact piece 44, and this arcuate edge is the arcuate contact portion 44F. A part of the spring contact piece 44 closer to the base end side than the arcuate contact portion 44F may contact the pin terminal 10.

The spring contact piece 44 includes a base end side region R1 and a tip side region R2 (see FIG. 4). The base end side region R1 is a region part extending from the tubular base portion 42 toward the tip of the tube portion 40. The tip side region R2 is a region part extending from the base end side region R1 toward a side away from the tubular base portion 42, i.e. further to the tip side of the tube portion 40.

An angle of inclination θ2 of the tip side region R2 with respect to the center axis X is smaller than an angle of inclination θ1 of the base end side region R1 with respect to the center axis X. That is, the tip side region R2 is more parallel to the center axis X than the base end side region R1. In this way, the tip side region R2 can be arranged at an inner peripheral position near the pin terminal 10 by the base end side region R1. Most region of the inner peripheral surface of the base end side region R1 can be brought into contact with the pin terminal 10 or arranged at a position very close to the pin terminal 10 by the base end side region R1.

The biasing member 50 is externally fit to the tube portion 40. The biasing member 50 applies a contact pressure to the pin terminal 10 by biasing the plurality of spring contact pieces 44 toward the inner peripheral side. That is, the spring contact pieces 44 are pressed against the pin terminal 10 by biasing forces due to their own resilient forces and a biasing force by the biasing member 50.

More specifically, the biasing member 50 includes a surrounding portion 52 and a crimping/fixing portion 58. The biasing member 50 is, for example, formed, such as by press-working one metal plate.

The surrounding portion 52 is arranged to surround the plurality of spring contact pieces 44 from the outer peripheral side. More specifically, the surrounding portion 52 includes a hollow semicylindrical intermediate portion 52a and extending portions 52b extending from both ends of the intermediate portion 52a. The extending portion 52b is shaped to be gradually narrower in a part coming out from the intermediate portion 52a, here in the form of a trapezoidal plate.

The extending portions 52b are connected to both end parts of the intermediate portion 52a, and the annular surrounding portion 52 is formed by the intermediate portion 52a and the two extending portions 52b.

Each of the intermediate portion 52a and the two extending portions 52b is formed with a partial protrusion 52p. The partial protrusion 52p is, for example, a hemispherical part projecting toward an inner peripheral side of the surrounding portion 52. The plurality of partial protrusions 52p are formed at positions capable of contacting the plurality of spring contact pieces 44 from the outer peripheral side. The plurality of partial protrusions 52p can contact outer peripheral parts of the plurality of spring contact pieces 44 in a one-to-one correspondence.

An inner diameter of a virtual circle connecting tops of the plurality of partial protrusions 52p on the inner peripheral side is smaller than an outer diameter of a virtual circle passing through outermost peripheral parts of parts of the plurality of spring contact pieces 44 where the surrounding portion 52 are mounted. Thus, with the surrounding portion 52 mounted on the plurality of spring contact pieces 44, the surrounding portion 52 is resiliently deformed to expand more than in an initial state. The plurality of spring contact pieces 44 are pressed toward the inner peripheral side by a resilient force of the surrounding portion 52 trying to return to an original shape. A biasing direction of the biasing member 50 is a direction for biasing the plurality of spring contact pieces 44 in a direction to narrow the gaps of the slits S.

Note that the formation of the partial protrusions 52p is not essential.

The biasing member 50 biases the plurality of spring contact pieces 44 toward the inner peripheral side by contacting the parts of the spring contact pieces 44 closer to the tip sides than the centers in the extension direction. Here, the surrounding portion 52 is located on the outer peripheral sides of the tip side regions R2, out of the plurality of spring contact pieces 44. The surrounding portion 52 biases the plurality of spring contact pieces 44 toward the inner peripheral side by contacting the outer peripheral surfaces of the respective tip side regions R2. Thus, heat generated in contact locations of the tip side regions R2 and the pin terminal 10 is effectively transferred to the surrounding portion 52.

The crimping/fixing portion 58 is a part crimped and fixed to the tube portion 40. In this embodiment, the crimping/fixing portion 58 extends from the surrounding portion 52 toward the base end part of one spring contact piece 44.

More specifically, the crimping/fixing portion 58 extends from the intermediate portion 52a of the surrounding portion 52. The crimping/fixing portion 58 extends along the outer peripheral surface of the one spring contact piece 44 and reaches the base end part of this spring contact piece 44. An embracing portion 58b including embracing pieces 58a extending on both sides is provided on a tip part of the crimping/fixing portion 58. This pair of embracing pieces 58a are passed through the both side surfaces of the base end part of the spring contact piece 44 and bent to face the inner peripheral side, whereby the crimping/fixing portion 58 is crimped and fixed to the spring contact piece 44. Projecting pieces 44a projecting laterally may be formed on a side of the spring contact piece 44 closer to the tip side than the embracing pieces 58a. These projecting pieces 44a can restrict the position deviation of the embracing pieces 58 to the tip side of the spring contact piece 44. A crimping/fixing portion may be crimped and fixed to a tubular base portion.

The embracing portion 58 and the surrounding portion 52 are coupled by a central coupling piece 59a extending from the embracing portion 58b toward the intermediate portion 52a and a pair of side coupling pieces 59b extending from the embracing portion 58b toward the both ends of the intermediate portion 52a. Openings are formed between the central coupling piece 59a and the pair of side coupling pieces 59b. In this way, a heat capacity of the biasing member 50 can be reduced and the temperature of the biasing member 50 can be effectively increased.

The biasing member 50 is made of shape-memory alloy remembering a form to increase a contact pressure of the spring contact pieces 44 and the pin terminal 10 by a temperature rise.

A temperature before the contact pressure is increased is a temperature at which an operation of connecting the pin terminal 10 to the socket terminal 20 is performed, and is, for example, a temperature belonging to normal temperature. The normal temperature is, for example, 25 °C±15 °C. A temperature mentioned below is a degree Celsius temperature.

The temperature at which the contact pressure is increased is a temperature higher than the temperature at which the operation of connecting the pin terminal 10 to the socket terminal 20 is performed. The temperature at which the contact pressure is increased may be, for example, a temperature higher than the normal temperature. The temperature at which the contact pressure is increased may be a temperature obtained by adding an influence of heating by Joule heat or the like to an operating environment temperature of this socket terminal 20. The temperature at which the contact pressure is increased may be, for example, a temperature equal to or higher than 50 °C.

That is, the form of the biasing member 50 may be memorized to increase the contact pressure by a temperature rise from a temperature range of 25 °C±15 °C to a temperature equal to or higher than 50 °C.

Form memory may be set to increase the contact pressure by changing the shape or physical values by a temperature rise.

For example, a virtual circle connecting parts located on innermost peripheral sides, out of the plurality of spring contact pieces 44 of the biasing member 50, is assumed as a minimum virtual circle. Here, the virtual circle connecting the tops of the plurality of partial protrusions 52p on the inner peripheral side is the minimum virtual circle. Shape is thought to be memorized to make a diameter of the minimum virtual circle after the contact pressure is increased smaller than that of the minimum virtual circle at the temperature before the contact pressure is increased. That is, the shape of the surrounding portion 52 is memorized to make the minimum virtual circle smaller by a temperature rise.

Further, the form of the biasing member 50 may be, for example, memorized to be able to increase a spring load due to an increase of an elastic modulus, which is an example of a physical value, by a temperature rise.

The shape-memory alloy may be, for example, a Ni—Ti alloy or a Ni—Ti—Cu alloy. If the shape-memory alloy is a Ni—Ti alloy or a Ni—Ti—Cu alloy, form memory can be set to change the shape and further increase the elastic modulus by a temperature change from the temperature range of 25 °C±15 °C to a temperature equal to or higher than 50 °C. In this way, a force of the biasing member 50 for biasing the spring contact pieces 44 toward the inner peripheral side can be increased by the temperature rise.

Note that the shape-memory alloy may be an alloy other than the Ni—Ti alloy or the Ni—Ti—Cu alloy.

The behavior of the socket terminal 20 is described.

In an initial state, the biasing member 50 is mounted on the outer periphery of the tube portion 40. Note that, before the temperature rise (e.g. at the normal temperature), the biasing member 50 is thought to be open to have a large diameter of the minimum virtual circle. Thus, the biasing member 50 can be easily mounted on the outer periphery of the tube portion 40.

As shown in FIG. 1, the pin terminal 10 is inserted into the tube portion 40 for connection with the tip side thereof in the lead. Then, the tip part of the pin terminal 10 contacts the parts located on the innermost peripheral sides, out of the plurality of spring contact pieces 44, here the arcuate contact portions 44F in the inner peripheral parts of the tip side regions R2. The plurality of spring contact pieces 44 are pushed and expanded toward the outer peripheral side to form a space, into which the pin terminal 10 is insertable. At this time, biasing forces F1 due to spring loads of the spring contact pieces 44 themselves and biasing forces F2 due to a spring load of the biasing member 50 act on the arcuate contact portions 44F of the spring contact pieces 44 (see FIG. 5). Thus, during an inserting operation of the pin terminal 10, a contact pressure by a resultant force of the biasing forces F1 and the biasing forces F2 acts between the spring contact pieces 44 and the pin terminal 10. Thus, a friction force proportional to the resulting force of the biasing forces F1 and the biasing forces F2 acts between the spring contact pieces 44 and the pin terminal 10.

The biasing forces F2 are smaller than biasing forces F3 after the temperature rise. Thus, a force required to connect the pin terminal 10 can be reduced. Further, the plating wear of the pin terminal 10 and the spring contact pieces 44 can be suppressed by reducing the contact pressure during the connecting operation. In this way, in the connected state of the pin terminal 10 and the spring contact pieces 44, functions of plating such as oxidation prevention and corrosion prevention are exhibited and high connection reliability is obtained.

Note that, also in a state where the inserting operation of the pin terminal 10 is finished, the contact pressure due to the resulting force of the biasing forces F1 and the biasing forces F2 acts between the pin terminal 10 and the spring contact pieces 44 at the normal temperature.

In the case of using the socket terminal 20 as a relay connection location of an electrical circuit, it is thought to electrically connect the power supply 18 to one of the socket terminal 20 and the pin terminal 10 and electrically connect the load 19 to the other. Thus, a current flows in the socket terminal 20 and the pin terminal 10.

If the current flows in the socket terminal 20 and the pin terminal 10, the temperatures of the socket terminal 20 and the pin terminal 10 are increased by Joule heat. The temperature is thought to be easily increased by Joule heat at the connection location of the socket terminal 20 and the pin terminal 10. The heat of the socket terminal 20 and the pin terminal 10 is transferred to the biasing member 50, and the temperature of the biasing member 50 also increases. In this way, the biasing member 50 is deformed into a memorized shape or the physical values such as the elastic modulus of the biasing member 50 are changed, and the spring load by the biasing member 50 increases. Then, the biasing forces F3 by the biasing member 50 become larger than the biasing forces F2. Thus, the contact pressure between the pin terminal 10 and the socket terminal 20 also increases. In this way, the socket terminal 20 and the pin terminal 10 are stably kept in a contact state also under vibration conditions. Further, electrical resistance between the socket terminal 20 and the pin terminal 10 is reduced and excessive heat generation is suppressed at the contact location.

For example, in the case of applying this socket terminal 20 to a power supply circuit or a circuit, to which a high voltage is applied, heat generation by Joule heat is expected. The high voltage is, for example, 60 V or more, more preferably 90 V or more.

However, this socket terminal 20 may be applied to a signal circuit or a circuit, to which a low voltage is applied.

A temperature rise of the biasing member 50 may be brought about by heat other than Joule heat in the socket terminal 20 and the pin terminal 10. For example, the temperature of the biasing member 50 may be increased by the heat of a control device or a drive circuit around the socket terminal 20, the heat of an internal combustion engine or the heat of a battery.

According to the socket terminal 20 configured as described above, the biasing member 50 applies a contact pressure to the pin terminal 10 by biasing the plurality of spring contact pieces 44 toward the inner peripheral side. Further, the biasing member 50 is made of shape-memory alloy remembering the form to increase the contact pressure by a temperature rise. Thus, the connecting operation is easily performed under a relatively small contact pressure condition by inserting the pin terminal into the tube portion 40 for connection in a state before the temperature rise. In this way, connection workability is easily performed with a low insertion force. Further, the plating wear of the socket terminal 20 and the pin terminal 10 during the connection is suppressed. Thus, the functions of the plating are exhibited in the connected state of the socket terminal 20 and the pin terminal 10, and the connection reliability of the both is ensured.

Further, since the contact pressure of the spring contact pieces 44 and the pin terminal 10 is increased by a temperature rise after the connection, high connection reliability can be obtained. Further, the plurality of spring contact pieces 44 are arranged along the circumferential direction of the tubular base portion 42 and surround the outer periphery of the pin terminal 10. Thus, heat generated in the connection location and the like of the pin terminal 10 and the tube portion 40 is easily transferred to the biasing member 50 via the spring contact pieces 44 arranged in the circumferential direction. In this way, the contact pressure is effectively increased and even higher connection reliability can be obtained.

Further, if the temperature returns to the normal temperature, the contact pressure of the socket terminal 20 and the pin terminal 10 returns to a relatively low pressure, wherefore maintenance associated with the insertion and withdrawal of the pin terminal 10 into and from the socket terminal 20 can be easily performed.

For example, it is assumed to increase a spring load of a terminal for vibration resistance and the suppression of heat generation at a contact point. In this case, there is a possibility that a force required for connection increases and connection workability is deteriorated. To enhance connection workability, a configuration for incorporating a lever utilizing the principle of leverage or utilizing a fastening force of a bolt is considered. In these cases, there is a possibility of weight increase, enlargement and complication.

According to this socket terminal 20, it is possible to facilitate a connecting operation and improve connection reliability while suppressing a weight increase, enlargement and enlargement. Note that, in the socket terminal 20, a connection structure utilizing the lever or bolt may be applied.

Further, the tubular base portion 42 is formed into a hollow cylindrical shape and, if the plurality of spring contact pieces 44 are arranged side by side in the circumferential direction by the tubular base portion 42, the plurality of spring contact pieces 44 can be formed into a shape suitable for the connection of the pin terminal 10 in the form of an easily processable round bar.

Further, if the inner peripheral parts of the spring contact pieces 44 include the arcuate contact portions 44F convex toward the outer peripheral side when viewed in the direction along the center axis X, a contact area of the arcuate contact portions with the pin terminal 10 can be increased. In this way, the connection reliability of the pin terminal and the spring contact pieces is improved. Further, heat is easily transferred from the pin terminal 10 to the biasing member 50 via the spring contact pieces 44 and the temperature of the biasing member 50 can be effectively increased.

Further, since the biasing member 50 biases the plurality of spring contact pieces 44 in a direction to narrow the gaps of the slits S, the spring contact pieces 44 can be smoothly resiliently deformed toward the inner and outer peripheral sides, utilizing the slits S, and the plurality of spring contact pieces 44 can contact the pin terminal 10 in a state where the biasing member 50 biases the spring contact pieces 44 with the slits S narrowed. In this way, as large a part as possible of the entire periphery of the pin terminal 10 can contact the spring contact pieces 44. In this way, the connection reliability of the pin terminal 10 and the spring contact pieces 44 is improved. Further, by narrowing the slits S, heat is easily transferred from the pin terminal 10 to the biasing member 50 via the spring contact pieces 44 and the temperature of the biasing member 50 can be effectively increased.

Further, since the biasing member 50 includes the crimping/fixing portion 58 crimped and fixed to the tube portion 40, the position deviation or detachment of the biasing member 50 from the tube portion 40 is suppressed even if the biasing force of the surrounding portion 52 is relatively small in a state before heating.

Further, the biasing member 50 biases the plurality of spring contact pieces 44 toward the inner peripheral side by contacting the parts of the spring contact pieces 44 closer to the tip sides than the centers in the extension direction. Thus, the biasing force of the pin terminal 10 can be increased as compared to the case where a biasing member biases base end sides of spring contact pieces.

Further, the plurality of spring contact pieces 44 can contact the pin terminal 10 at the positions closer to the tip sides than the centers thereof in the extension direction. Here, the arcuate contact portion 44F is located on the tip side of the spring contact piece 44. The spring contact piece 44 is resiliently deformed to swing with the base end as a center. Thus, the arcuate contact portion 44F for contacting the pin terminal 10, out of the spring contact piece 44, can be largely displaced as compared to the case where a contact portion with a pin terminal is located near the base end of a spring contact piece. In this way, a contact state with the pin terminal 10 is easily adjusted by slight deformation of the spring contact piece 44.

Further, the spring contact piece 44 includes the base end side region R1 and the tip side region R2, and the angle of inclination θ2 of the tip side region R2 is smaller than the angle of inclination θ1 of the base end side region R1. At least a part of the tip side region R2 is in contact with the pin terminal 10. Thus, the tip side region R2 having the small angle of inclination θ1 can be brought into contact with the pin terminal 10 over as large a contact area as possible or the tip side region R2 is easily arranged at a position as close to the outer peripheral surface of the pin terminal 10 as possible. In this way, heat generated in the pin terminal 10 is effectively transferred to the biasing member 50 via the tube portion 40. In this way, the biasing force by the biasing member 50 is easily increased.

Further, the biasing member 50 biases the plurality of spring contact pieces 44 toward the inner peripheral side by contacting the tip side regions R2. Thus, heat can be effectively transferred to the biasing member 50 in contact with the tip side regions R2, and the biasing member 50 can effectively generate the contact pressure.

Further, if the biasing member 50 is made of Ni—Ti alloy or Ni—Ti—Cu alloy, the shape of the biasing member 50 can be returned to the original shape by shape memory during a temperature rise, and the contact pressure of the socket terminal 20 and the pin terminal 10 can be increased by increasing the elastic modulus.

Note that the respective configurations described in the above embodiment and the respective modifications can be appropriately combined without technically contradicting each other.

### LIST OF REFERENCE NUMERALS

10 pin terminal
18 power supply
19 load
20 socket terminal
30 terminal body
32 wire connecting portion
40 tube portion
42 tubular base portion
44 spring contact piece
44F arcuate contact portion
44a projecting piece
50 biasing member
52 surrounding portion
52a intermediate portion
52b extending portion
52p partial protrusion
58 crimping/fixing portion
58a embracing piece
58b embracing portion
59a central coupling piece
59b side coupling piece
F1, F2, F3 biasing force
H housing
R1 base end side region
R2 tip side region
S slit
W wire
X center axis
θ1 angle of inclination of base end side region
θ2 angle of inclination of tip side region

1. A socket terminal to be connected to a pin terminal while being accommodated in a housing made of resin, comprising:
a tube portion including a tubular base portion and a plurality of spring contact pieces arranged in a circumferential direction of the tubular base portion; and
a biasing member externally fit to the tube portion,
each of the plurality of spring contact pieces extending from the tubular base portion along an axial direction of the tubular base portion and resiliently deformable in a radial direction of the tubular base portion,
the biasing member applying a contact pressure to the pin terminal from each of the plurality of spring contact pieces by biasing each of the plurality of spring contact pieces toward an inner peripheral side,
the biasing member being made of shape-memory alloy remembering a form to increase the contact pressure by a temperature rise, and
the pin terminal and the tube portion being in such a contact state as to increase a temperature of the biasing member and increase the contact pressure by Joule heat generated by a current flowing in the pin terminal and the tube portion.

2. The socket terminal of claim 1, wherein the tubular base portion is formed into a hollow cylindrical shape.

3. The socket terminal of claim 2, wherein an inner peripheral part of each of the plurality of spring contact pieces includes an arcuate contact portion convex toward an outer peripheral side when viewed in a direction along a center axis of the tubular base portion.

4. The socket terminal of claim 1, wherein:
a slit is present between two adjacent ones of the plurality of spring contact pieces, and
the biasing member biases each of the plurality of spring contact pieces in a direction to narrow a gap of the slit.

5. The socket terminal of claim 1, wherein the biasing member includes a surrounding portion for surrounding the plurality of spring contact pieces from an outer peripheral side and a crimping/fixing portion crimped and fixed to the tube portion.

6. The socket terminal of claim 1, wherein the biasing member biases each of the plurality of spring contact pieces toward the inner peripheral side by contacting a part of each of the plurality of spring contact pieces closer to a tip side than a center thereof in an extension direction.

7. The socket terminal of claim 1, wherein each of the plurality of spring contact pieces is capable of contacting the pin terminal at a position closer to a tip side than a center thereof in an extension direction.

8. The socket terminal of claim 1, wherein:
the spring contact piece includes a base end side region extending from the tubular base portion and a tip side region extending from the base end side region toward a side away from the tubular base portion, and
an angle of inclination of the tip side region with respect to a center axis of the tubular base portion is smaller than an angle of inclination of the base end side region with respect to the center axis of the tubular base portion, and
at least a part of the tip side region is capable of contacting the pin terminal.

9. The socket terminal of claim 8, wherein the biasing member biases each of the plurality of spring contact pieces toward the inner peripheral side by contacting the tip side region.

10. The socket terminal of claim 1, wherein the biasing member is made of Ni—Ti alloy or Ni—Ti—Cu alloy.
